(19) United States
(12) Patent Application Publication
(10) Pub. No.: US 2014/0025469 A1
(43) Pub. Date: Jan. 23, 2014

(54) REWARD GRANTING APPARATUS, REWARD GRANTING METHOD, AND REWARD GRANTING PROGRAM

(71) Applicant: CAREWARD, INC., Tokyo (JP)

(72) Inventor: Jin Mishuku, Tokyo (JP)

(73) Assignee: CAreward, Inc., Tokyo (JP)

(21) Appl. No.: 13/766,635

(22) Filed: Feb. 13, 2013

(30) Foreign Application Priority Data
Jul. 18, 2012 (JP) 2012-159834

(51) Int. Cl. G06Q 30/02

(52) U.S. Cl. CPC G06Q 30/0225
USPC 705/14.26

(57) ABSTRACT

The reward granting apparatus has: a first determination unit, which determines whether or not a session ID is registered in a DB, this session ID being associated with a user ID and an application ID included in a application activation request message; an application activation command unit, which issues an application activation command that includes the session ID, the user ID, and the application ID, when the session ID is registered in the DB; a session ID extraction unit, which extracts from the DB the session ID corresponding to the user ID and the application ID included in a reward request message; a second determination unit, which determines whether or not the extracted session ID matches the session ID included in the reward request message; and a reward granting unit, which executes a process for granting a reward when both of the session IDs match.

### CROSS-REFERENCE TO RELATED APPLICATION

This application is based upon and claims the benefit of priority of Japanese Patent Application No. 2012-159834 filed on Jul. 18, 2012, the disclosure of which is hereby incorporated by reference herein in its entirety.

### BACKGROUND

The present invention relates to a reward granting apparatus, a reward granting method, and a reward granting program.

An advertising technique called affiliate marketing has drawn attention recently as a cost-effective advertising technique. Affiliate marketing is an advertising technique in which when a user clicks on an advertisement posted on an advertisement posting website to purchase an advertised product from an advertiser's website, a result reward is paid to an administrator of the advertisement posting website from the advertiser.

A system that realizes affiliate marketing pays a result reward when a user who clicks on an advertisement on an advertisement posting website matches a user who purchases an advertised product on an advertiser's website. In this case, when the user accesses the advertisement from a fixed terminal such as a personal computer, the system can use cookies to determine whether or not the user matches the user purchasing the advertised product. However, when the user accesses the advertisement from a mobile terminal, the system cannot use cookies. Therefore, a mechanism for determining whether or not the user matches the user purchasing the advertised product, needs to be incorporated in the system.

Patent Publication JP-A-2006-293754 discloses a server device that calculates a result reward for each advertisement posting agency, in a system for providing content services to mobile phones. This server device acquires a UID of a mobile phone from a mobile phone network and, by using this UID determines whether both users match or not.

Because the server device described in Patent Publication JP-A-2006-293754 is designed to pay a result reward to an advertisement posting agency, the advertisement posting agency makes an effort to have users click on an advertisement thereof. However, the server device is not provided with a mechanism in which a user can profit from clicking on an advertisement. Thus, this server device has room for improvement in order to improve the cost effectiveness of its advertisement.

### SUMMARY

The present invention was contrived in view of the problems described above, and an object thereof is to provide a reward granting apparatus, a reward granting method, and a reward granting program, which are capable of granting a profit to a user for using an advertisement posting website.

A reward granting apparatus according to one aspect of the present invention is a reward granting apparatus for granting a reward to a user who downloads an application, the reward granting apparatus having: a first determination unit, which, when an application activation request message that includes at least a user ID for specifying a user requesting for activation of the application and an application ID for specifying the application is received, determines whether or not a session ID is registered in a storage device, this session ID being associated with the user ID and the application ID included in the application activation request message and indicating that the application is downloaded from an advertisement posting website serving as an origin; an application activation command unit, which issues an application activation command that includes the session ID, the user ID, and the application ID in a parameter, when the first determination unit determines that the session ID is registered in the storage device; a session ID extraction unit, which, when a reward request message that includes at least the session ID, the use ID and the application ID is received, extracts from the storage device the session ID corresponding to the user ID and the application ID included in the reward request message; a second determination unit, which determines whether or not the session ID extracted by the session ID extraction unit matches the session ID included in the reward request message; and a reward granting unit, which executes a process for granting a reward to the user when the second determination unit determines that both of the session IDs match.

A reward granting method according to one aspect of the present invention is a reward granting method for granting a reward to a user who downloads an application, the reward granting method having: a first determination step of, when an application activation request message that includes at least a user ID for specifying a user requesting for activation of the application and an application ID for specifying the application is received, determining whether or not a session ID is registered in a storage device, this session ID being associated with the user ID and the application ID included in the application activation request message and indicating that the application is downloaded from an advertisement posting website serving as an origin; an application activation command step of issuing an application activation command that includes the session ID, the user ID, and the application ID in a parameter, when the first determination step determines that the session ID is registered in the storage device; a session ID extraction step of, when a reward request message that includes at least the session ID, the user ID and the application ID is received, extracting from the storage device the session ID corresponding to the user ID and the application ID included in the reward request message; a second determination step of determining whether or not the session ID extracted in the session ID extraction step matches the session ID included in the reward request message; and a reward granting step of executing a process for granting a reward to the user when the second determination step determines that both of the session IDs match.

A reward granting program according to one aspect of the present invention causes a computer to execute: a first determination step of, when an application activation request message that includes at least a user ID for specifying a user requesting for activation of an application and an application ID for specifying the application is received, determining whether or not a session ID is registered in a storage device, this session ID being associated with the user ID and the application ID included in the application activation request message and indicating that the application is downloaded from an advertisement posting website serving as an origin; an application activation command step of issuing an application activation command that includes the session ID, the user ID, and the application ID in a parameter, when the first determination step determines that the session ID is registered in the storage device; a session ID extraction step of, when a reward request message that includes at least the session ID, the user ID and the application ID is received, extracting from the storage device the session ID corresponding to the user ID and the application ID included in the reward request message; a second determination step of determining whether or not the session ID extracted in the session ID extraction step matches the session ID included in the reward request message; and a reward granting step of executing a process for granting a reward to the user when the second determination step determines that both of the session IDs match.

According to the configuration described above, when the application activation request message is received, it can be determined whether the session ID, which indicates that the application is downloaded from the advertisement posting website serving as an origin, is registered in the storage device or not. When the session ID is registered, the application activation command that includes the session ID, the user ID and the application ID in the parameter can be issued. When the reward request message is received, the session ID that corresponds to the user ID and the application ID included in the reward request message is extracted from the storage device. When the extracted session ID matches the session ID included in the reward request message, the process for granting a reward to the user can be executed.

The reward granting apparatus may further include a session ID issuing unit that issues the session ID when a download request message including at least the user ID and the application ID is received, and a registering unit that associates the session ID issued by the session ID issuing unit with the user ID and the application ID included in the download request message and registers the resultant session ID in the storage device.

Accordingly, when the download request message is received, the session ID can be issued, associated with the user ID and the application ID included in the download request message, and registered in the storage device.

In the reward granting apparatus, the reward request message may further include identification information that is generated with respect to the application ID in a mobile terminal in which the application is activated, based on the application activation command, and the reward granting unit may not execute the process for granting a reward, when the identification information included in the reward request message matches any of identification information items received in the past.

Thus, when the identification information included in the reward request message matches any of the identification information items received in the past, the execution of the process for granting a reward can be prohibited.

In the reward granting apparatus, the application activation command may further include, in the parameter, information for specifying an advertisement posting page for an application corresponding to the application ID included in the parameter.

Accordingly, the application activation command and the information for specifying an advertisement posting page for the application can be sent to a mobile terminal.

The present invention can grant a profit to a user who uses an advertisement posting website.

### DESCRIPTION OF THE DRAWINGS

FIG. 1 is a diagram showing a configuration of a communication system including a reward granting apparatus according to an embodiment;

FIG. 2 is a diagram showing a functional configuration of the reward granting apparatus shown in FIG. 1;

FIG. 3 is a diagram showing an advertisement posting page displayed on a screen of a smartphone shown in FIG. 1;

FIG. 4 is a flowchart for explaining an operation performed when granting a point to a user of the smartphone; and

FIG. 5 is a flowchart for explaining an operation performed when granting a point to the user of the smartphone.

### DETAILED DESCRIPTION

A preferred embodiment of a reward granting apparatus, a reward granting method, and a reward granting program according to the present invention is described hereinafter with reference to the accompanying drawings.

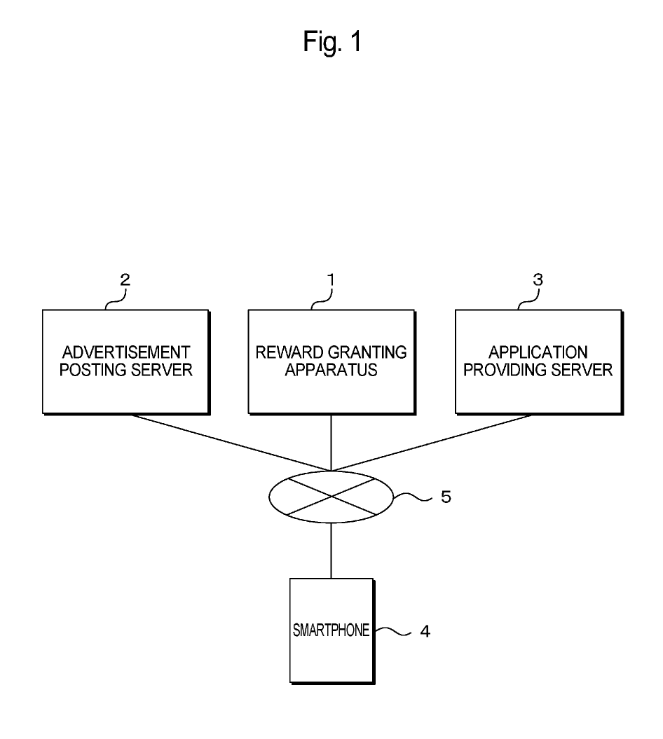

First, a configuration of a communication system including the reward granting apparatus according to the embodiment is described with reference to FIG. 1. This communication system has a reward granting apparatus 1, an advertisement posting server 2, an application providing server 3, and a smartphone 4. The reward granting apparatus 1, the advertisement posting server 2, the application providing server 3, and the smartphone 4 can mutually be connected by a network 5 such as the Internet or a mobile communication network.

The advertisement posting server 2 is a web server that manages an advertisement posting website for posting advertisements for, for example, products, services, and other applications for smartphones. The application providing server 3 is a web server that manages an application providing website for providing, for example, applications for smartphones. The smartphone 4 is a mobile terminal having a combination of a mobile phone function and a personal digital assistance function.

The reward granting apparatus 1 is an apparatus for granting a point, or a reward, to a user of the smartphone 4 when the smartphone 4 purchases an application from the advertisement posting website.

The reward granting apparatus 1 physically includes, for example, a CPU (Central Processing Unit), a storage device, and an input/output interface. The storage device includes, for example, a ROM (Read Only Memory) or HDD (Hard Disk Drive) for storing programs and data processed by the CPU, a RAM (Random Access Memory) that is used mainly as an area for executing various tasks for control processing, and the like. These elements are connected to one another by a bus. Functions of the components of the reward granting apparatus 1 that are described hereinafter are realized by causing the CPU to execute the programs stored in the ROM and process messages received through the input/output interface or data expanded in the RAM.

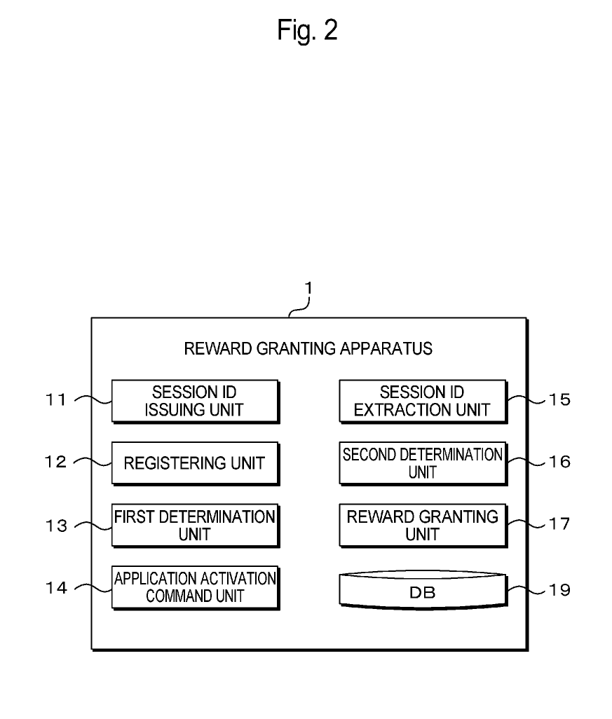

A functional configuration of the reward granting apparatus according to the embodiment is described with reference to FIG. 2. The reward granting apparatus 1 functionally has, for example, a session ID issuing unit 11, a registering unit 12, a first determination unit 13, an application activation command unit 14, a session ID extraction unit 15, a second determination unit 16, and a reward granting unit 17. The reward granting apparatus 1 also has a DB (database) 19 for storing various data.

The session ID issuing unit 11 issues session IDs when receiving download request messages for requesting download of applications. The session IDs are each a piece of identification information issued for each request for download and are used to allow the reward granting apparatus 1 to identify the fact that the smartphone 4 sends a request for download.

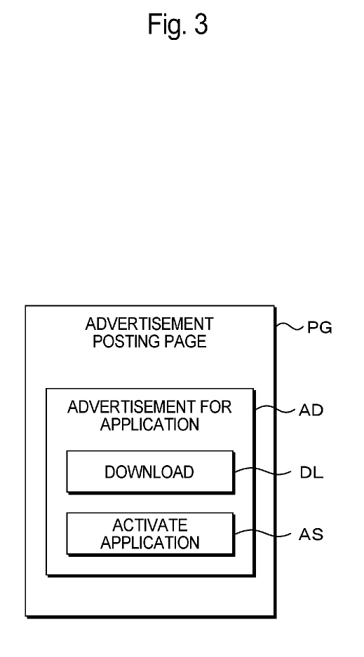

An advertisement posting page that is displayed on a screen of the smartphone 4 is now described with reference to FIG. 3 in order to explain a download request message. FIG. 3 is a diagram showing an example of the advertisement posting page.

On an advertisement posting page PG shown in FIG. 3, an advertisement AD for a smartphone application is posted differentially for each application. A region for displaying the advertisement AD for one application is provided with a “download” button DL and an “activate application” button AS.

When a user clicks the “download” button DL, the smartphone 4 transmits a download instruction to the advertisement posting server 2, and then the advertisement posting server 2 transmits a download request message to the reward granting apparatus 1.

The download request message includes, for example, a user ID, a medium ID, and an advertisement ID. The user ID is a piece of identification information for specifying a user who sends a request for download of an application. The medium ID is a piece of identification information for specifying a medium that posts the advertisement AD for an application to be downloaded. The advertisement ID is a piece of identification information for specifying the advertisement AD for the application to be downloaded.

When the user clicks the “activate application” button AS, the smartphone 4 transmits an application activation instruction to the advertisement posting server 2, and then the advertisement posting server 2 transmits an application activation request message requesting for activation of the application to the reward granting apparatus 1.

The application activation request message includes, for example, a user ID, a medium ID, and an advertisement ID. The user ID is a piece of identification information for specifying a user who sends a request for activation of the application. The medium ID is a piece of identification information for specifying the medium that posts the advertisement AD for the application to be activated. The advertisement ID is a piece of identification information for specifying the advertisement AD for the application to be activated.

The registering unit 12 shown in FIG. 2 associates a session ID issued by the session ID issuing unit 11 with the user ID, the medium ID, and the advertisement ID included in the download request message, and registers the resultant session ID in the DB 19.

When the application activation request message is received, the first determination unit 13 determines whether the session ID corresponding to the user ID, the medium ID, and the advertisement ID included in the application activation request message is registered in the DB 19 or not.

When the first determination unit 13 determines that the session ID is registered in the DB 19, the application activation command unit 14 causes the advertisement posting server 2 to issue an application activation command that includes the session ID, the user ID, the medium ID, and the advertisement ID in a parameter.

The application activation command can be issued using, for example, a URL scheme. Specifically, a URL scheme that designates an application name (e.g., “ABC”) corresponding to the advertisement AD for an application is set in the “activate application” button AS shown in FIG. 3 (e.g., “ABC://”). Consequently, by clicking the “activate application” button AS, the application “ABC” installed in the smartphone 4 can be activated. By designating a parameter to be delivered to the application in the parameter of the URL scheme, the parameter can be delivered to the application “ABC.”

In the present embodiment, a program name of an SDK (Software Development Kit) incorporated in the application corresponding to the advertisement AD is designated as the application name of the URL scheme, and then the session ID, the user ID, the medium ID, and the advertisement ID are designated in the parameter of the URL scheme. Therefore, when the “activate application” button AS is clicked, the SDK that is incorporated in the application installed on the smartphone 4 can be operated and then the application can be activated.

Contents of processes that are executed in the operation of the SDK are described hereinafter. First, the SDK generates random numbers. The SDK generates a UU (Universally Unique) ID by adding a key to be issued for each application to each random number. This UUID is a piece of identification information generated for each application. Prior to generating the UUID, the SDK checks for duplicate UUIDs. When an application already has a UUID, the SDK does not generate a UUID for the application. Therefore, even in a case of deleting an installed application and then re-downloading and re-installing the same application, the UUID of the deleted application can be kept as-is.

Subsequently, the SDK generates a UI (Unique Installation) ID by combining the date/time when the UUID is generated and the UUID. The SDK then stores the generated UIID in a secure storage. The secure storage is, for example, a storage that can be accessed only by an application that uses a region of the storage, and corresponds to a storage capable of retaining the UIID of the application even after the application is deleted.

The SDK then sends a reward request message requesting for a reward for downloading the application, to the reward granting apparatus 1 through socket communication.

The reward request message includes, for example, a session ID, a user ID, a medium ID, an advertisement ID, and a UIID. The user ID is a piece of identification information for specifying a user requesting for a reward. The medium ID is a piece of identification information for specifying a medium that posts the advertisement AD for an application that is a target of the reward. The advertisement ID is a piece of identification information for specifying the advertisement AD for the application that is a target of the reward. The UIID is a piece of identification information that is generated by the smartphone 4 for each installed application.

When the reward request message is received, the session ID extraction unit 15 extracts, from the DB 19, the session ID corresponding to the user ID, the medium ID, and the advertisement ID included in the reward request message.

The second determination unit 16 determines whether the session ID extracted by the session ID extraction unit 15 matches the session ID included in the reward request message.

When the second determination unit 16 determines that the both session IDs match, the reward granting unit 17 transmits a point back notification to the smartphone 4, the point back notification indicating that a point is granted to the user of the smartphone 4.

When the UIID included in the reward request message matches any of the UIIDs received in the past, the reward granting unit 17 does not transmit the point back notification to the smartphone 4. This can prevent a redundant point from being granted to the same user.

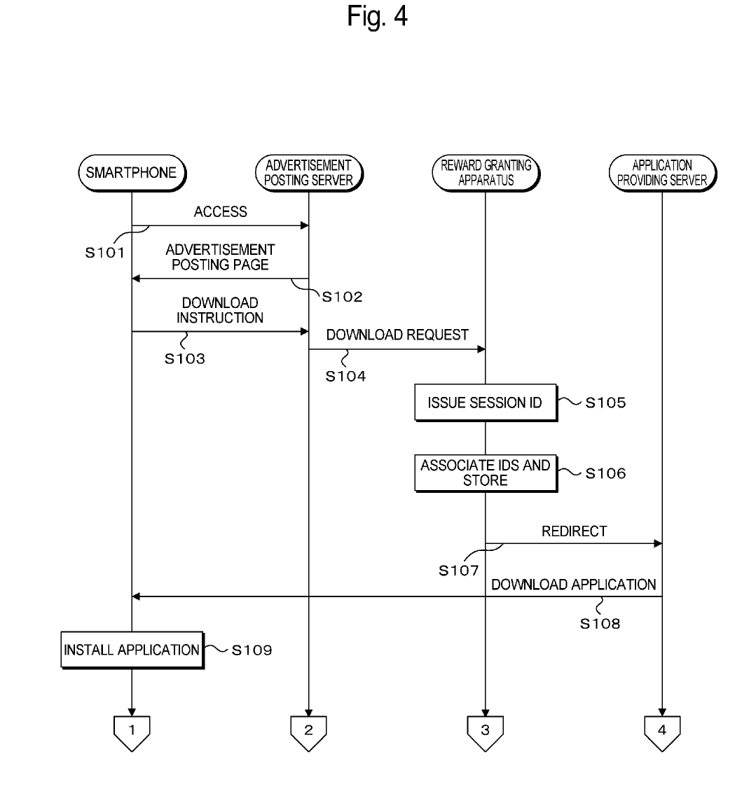

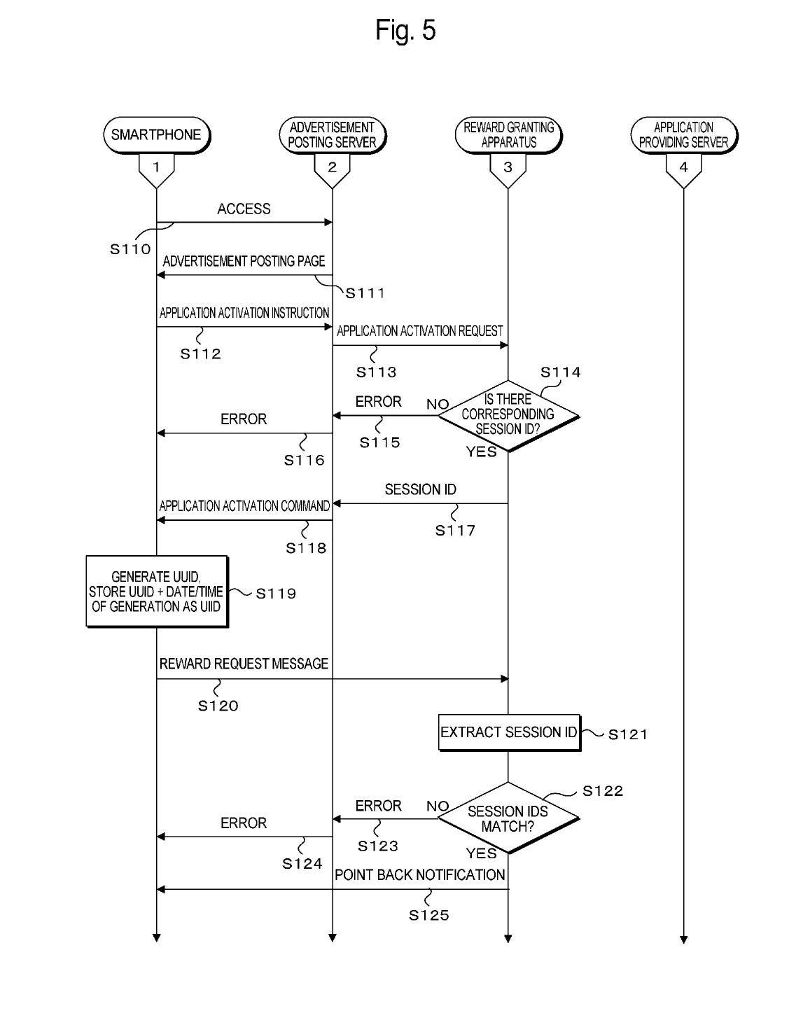

An operation for granting a point to the user of the smartphone 4 is described next with reference to FIGS. 4 and 5.

First, the smartphone 4 accesses the advertisement posting website (step S101) to display the advertisement posting page on the screen of the smartphone 4 (step S102).

When the user clicks the “download” button that is provided on the advertisement posting page displayed on the screen of the smartphone 4, the smartphone 4 transmits a download instruction to the advertisement posting server 2 (step S103), and the advertisement posting server 2 receives the download instruction.

Next, the advertisement posting server 2 transmits the download request message including the user ID, the medium ID and the advertisement ID to the reward granting apparatus 1 (step S104), and the reward granting apparatus 1 receives the download request message.

Subsequently, the session ID issuing unit 11 of the reward granting apparatus 1 issues the session ID (step S105).

Next, the registering unit 12 of the reward granting apparatus 1 associates the user ID, the medium ID and the advertisement ID that are included in the download request message transmitted in step S104, with the session ID issued in step S105, and registers the resultant session ID in the DB 19 (step S106).

Then, the reward granting apparatus 1 redirects the destination of the smartphone 4 to the application providing website that is the original destination for the download request (step S107).

The application providing server 3 then downloads the application corresponding to the download request message onto the smartphone 4 (step S108).

Subsequently, the smartphone 4 installs the application downloaded in step S108 (step S109).

Next, the smartphone 4 accesses the advertisement posting website again (step S110) to display the advertisement posting page on the screen of the smartphone 4 (step S111).

When the user clicks the “activate application” button that is provided on the advertisement posting page displayed on the screen of the smartphone 4, the smartphone 4 transmits an application activation instruction message to the advertisement posting server 2 (step S112), and the advertisement posting server 2 receives the application activation instruction message.

Next, the advertisement posting server 2 transmits the application activation request message including the user ID, the medium ID and the advertisement ID to the reward granting apparatus 1 (step S113), and the reward granting apparatus 1 receives the application activation request message.

Subsequently, the first determination unit 13 of the reward granting apparatus 1 determines whether the session ID, which corresponds to the user ID, the medium ID and the advertisement ID included in the application activation request message transmitted in step S113, is registered in the DB 19 or not (step S114). When the result of the determination is NO (step S114; NO), the reward granting apparatus 1 transmits an error message to the advertisement posting server 2 (step S115), and the advertisement posting server 2 transfers the error message to the smartphone 4 (step S116).

However, when it is determined in step S114 that the session ID is registered in the DB 19 (step S114; YES), the application activation command unit 14 of the reward granting apparatus 1 transmits the session ID registered in the DB 19 to the advertisement posting server 2 (step S117), and the advertisement posting server 2 receives this session ID.

Next, the advertisement posting server 2 issues the application activation command that includes the session ID transmitted in step S117, the user ID, the medium ID, and the advertisement ID in the parameter, to the smartphone 4 (step S118), and the smartphone 4 receives this application activation command.

The smartphone 4 then operates the SDK that is incorporated in the application installed in step S109, to generate “UUID,” and then stores “UUID”+“date/time of generation” as “UIID” in the storage (step S119).

Subsequently, the smartphone 4 transmits, to the reward granting apparatus 1, the reward request message that includes not only the session ID, the user ID, the medium ID, and the advertisement ID that are included in the application activation command issued in step S118, but also the UIID stored in the memory in step S119 (step S120). The reward granting apparatus 1 receives this reward request message.

Next, the session ID extraction unit 15 of the reward granting apparatus 1 extracts from the DB 19 the session ID that corresponds to the user ID, the medium ID and the advertisement ID that are included in the reward request message transmitted in step S120 (step S121).

Then, the second determination unit 16 of the reward granting apparatus 1 determines whether the session ID extracted in step S121 matches the session ID that is included in the reward request message transmitted in step S120 (step S122). When the result of the determination is NO (step S122; NO), the reward granting apparatus 1 transmits an error message to the advertisement posting server 2 (step S123), and the advertisement posting server 2 transfers this error message to the smartphone 4 (step S124).

However, when it is determined in step S122 that the both session IDs match (step S122; YES), the reward granting unit 17 of the reward granting apparatus 1 transmits a point back notification to the smartphone 4, the point back notification indicating that a point is granted to the user of the smartphone 4 (step S125), and the smartphone 4 receives the point back notification.

According to the reward granting apparatus 1 of the embodiment described above, when the application activation request message is received, the first determination unit 13 can determine whether the session ID, indicating that the application is downloaded from the advertisement posting website serving as an origin is registered in the DB 19 or not. When the session ID is registered, the application activation command unit 14 can issue the application activation command that includes the session ID, the user ID and the application ID in the parameter. When the reward request message is received, the session ID extraction unit 15 can extract from the DB 19 the session ID corresponding to the user ID and the application ID included in the reward request message. Also, the second determination unit 16 can determine whether the extracted session ID matches the session ID included in the reward request message. Moreover, the reward granting unit 17 can execute the process for granting a reward to the user when the both session IDs match.

Therefore, the session IDs can be used to determine whether or not the user requesting for a reward is the user who downloads the application from the advertisement posting website serving as an origin. As a result, a reward can be granted to the valid user who downloads the application. Consequently, a profit can be granted to the user who uses the advertisement posting website.

According to the reward granting apparatus 1 of the embodiment, when the download request message is received, the session ID issuing unit 11 can issue the session ID, and the registering unit 12 can associate the issued session ID with the user ID and the application ID included in the download request message and register the resultant session ID in the DB 19.

When the application is downloaded from the advertisement posting website serving as an origin, the user ID and the application ID, associated with the session ID indicating the download, can be registered in the DB 19. Therefore, the presence/absence of download can be confirmed by designating a combination of a user and an application.

According to the reward granting apparatus 1 of the embodiment, the reward request message can include the UUID that is generated for each application of the smartphone 4, and checking for duplicate UUIDs can be performed, preventing a redundant point from being granted to the same user.

[Modification]

The embodiment described above is merely illustrative and is not to be construed to preclude the application of various modifications or technologies that are not disclosed in the embodiment. In other words, the present invention can be implemented in various forms without departing from the scope of the present invention.

For example, the embodiment above has described an aspect of having the advertisement posting server 2 but is not limited thereto. For instance, the present invention can be applied when the reward granting apparatus 1 posts an advertisement for an application. In this case, the reward granting apparatus 1 may function as the advertisement posting server 2 of the embodiment described above.

The download request message, the application activation request message, the application activation command, and the reward request message that are described in the embodiment each include the medium ID and the advertisement ID; however, since the reward granting apparatus 1 may be able to specify the application, the application ID for specifying the application may be used in place of the medium ID and the advertisement ID.

Furthermore, the parameter of the application activation command according to the embodiment described above may further include information for specifying the advertisement posting page for an application. A URL (uniform resource locator), for example, corresponds to the information for specifying the advertisement posting page. In this case, the SDK displays a popup screen that is provided with an option for enabling “returning to the advertisement posting page without activating the application,” on the screen of the smartphone, prior to activating the application. Then, when this option is selected on the popup screen, the SDK executes a process for shifting to the advertisement posting page without activating the application. Consequently, the user, who downloads the application for the purpose of acquiring a point, can acquire a point without activating the application.

The reward granting unit 17 according to the embodiment described above transmits the point back notification to the smartphone 4 in order to process the reward request message; however, the method for processing the reward request message is not limited thereto. Any process for granting a reward to the user of the smartphone 4 can be executed. For example, a notification may be sent in order to grant a point to a point system for granting a point to the user.

The embodiment described above implements the present invention with a single reward granting apparatus 1, but the present invention can be implemented with a plurality of apparatuses. In this case, the functions of the reward granting apparatus 1 according to the embodiment described above may be distributed to a plurality of apparatuses, and a group of the plurality of apparatuses may be caused to function as the reward granting apparatus 1 according to the embodiment described above.

Elements depicted in the figures are summarized below.
1 Reward granting apparatus
2 Advertisement posting server
3 Application providing server
4 Smartphone
5 Network
11 Session ID issuing unit
12 Registering unit
13 First determination unit
14 Application activation command unit
15 Session ID extraction unit
16 Second determination unit
17 Reward granting unit

What is claimed is:

1. A reward granting apparatus for granting a reward to a user who downloads an application, the reward granting apparatus comprising:
a first determination unit, which, when an application activation request message that includes at least a user ID for specifying a user requesting for activation of the application and an application ID for specifying the application is received, determines whether or not a session ID is registered in a storage device, this session ID being associated with the user ID and the application ID included in the application activation request message and indicating that the application has been downloaded from an advertisement posting website serving as an origin;
an application activation command unit, which issues an application activation command that includes the session ID, the user ID, and the application ID in a parameter, when the first determination unit determines that the session ID is registered in the storage device;
a session ID extraction unit, which, when a reward request message that includes at least the session ID, the use ID and the application ID is received, extracts from the storage device the session ID corresponding to the user ID and the application ID included in the reward request message;
a second determination unit, which determines whether or not the session ID extracted by the session ID extraction unit matches the session ID included in the reward request message; and
a reward granting unit, which executes a process for granting a reward to the user when the second determination unit determines that both of the session IDs match.

2. The reward granting apparatus according to claim 1, further comprising:
a session ID issuing unit, which issues the session ID when a download request message that includes at least the user ID and the application ID is received; and
a registering unit, which associates the session ID issued by the session ID issuing unit with the user ID and the application ID included in the download request message, and registers the resultant session ID in the storage device.

3. The reward granting apparatus according to claim 1, wherein
the reward request message further includes identification information that is generated with respect to the application ID in a mobile terminal in which the application is activated, based on the application activation command, and
when the identification information included in the reward request message matches any of identification information items received in the past, the reward granting unit does not execute the process for granting a reward.

4. The reward granting apparatus according to claim 1, wherein the application activation command further includes, in the parameter, information for identifying an advertisement posting page for an application corresponding to the application ID included in the parameter.

5. A reward granting method for granting a reward to a user who downloads an application, the reward granting method comprising:
a first determination step of, when an application activation request message that includes at least a user ID for specifying a user requesting for activation of the application and an application ID for specifying the application is received, determining whether or not a session ID is registered in a storage device, this session ID being associated with the user ID and the application ID included in the application activation request message and indicating that the application is downloaded from an advertisement posting website serving as an origin;
an application activation command step of issuing an application activation command that includes the session ID, the user ID, and the application ID in a parameter, when the first determination step determines that the session ID is registered in the storage device;
a session ID extraction step of, when a reward request message that includes at least the session ID, the use ID and the application ID is received, extracting from the storage device the session ID corresponding to the user ID and the application ID included in the reward request message;
a second determination step of determining whether or not the session ID extracted in the session ID extraction step matches the session ID included in the reward request message; and
a reward granting step of executing a process for granting a reward to the user when the second determination step determines that both of the session IDs match.

6. A reward granting program for causing a computer to execute:
a first determination step of, when an application activation request message that includes at least a user ID for specifying a user requesting for activation of an application and an application ID for specifying the application is received, determining whether or not a session ID is registered in a storage device, this session ID being associated with the user ID and the application ID included in the application activation request message and indicating that the application is downloaded from an advertisement posting website serving as an origin;
an application activation command step of issuing an application activation command that includes the session ID, the user ID, and the application ID in a parameter, when the first determination step determines that the session ID is registered in the storage device;
a session ID extraction step of, when a reward request message that includes at least the session ID, the use ID and the application ID is received, extracting from the storage device the session ID corresponding to the user ID and the application ID included in the reward request message;
a second determination step of determining whether or not the session ID extracted in the session ID extraction step matches the session ID included in the reward request message; and
a reward granting step of executing a process for granting a reward to the user when the second determination step determines that both of the session IDs match.
